(19) United States
(12) Patent Application Publication
(10) Pub. No.: US 2004/0216338 A1
(43) Pub. Date: Nov. 4, 2004

(54) Card manufacturing system and card

(76) Inventors: Kazuhiko Tsuji, Kawaguchi-shi (JP); Nobuaki Suzuki, Soka-shi (JP)

Correspondence Address: Kazuhiko Tsuji, Hopefull Manshion #206, 1-19 kamiaoki 1-chome, Kawaguchi-shi, Saitama, 333-0844, JP

(21) Appl. No.: 10/427,763

(22) Filed: Apr. 30, 2003

(51) Int. Cl. G09F 1/00

(52) U.S. Cl. 40/124.08

(57) ABSTRACT

A card comprises a card body; a running-out part provided at the card body; means for forming the running-out part, capable of jumping the running-out part out from the card body in three dimensions; an predetermined printing part provided at the card body, using in common; and a printing column provided at the card part except for a part of means for forming the running-out part so that it can produce a three-dimensional effect and make people fun and happy, and it is easy to print for any order of applicant, and everyone can use efficiently.

### BACKGROUND OF THE INVENTION

The present invention relates to a card and system for manufacturing the card.

Conventionally, there are the cards and books with a cut part or folding part so that a running-out part is formed after printing.

Moreover, they are separated from the main part of pasteboard.

The conventional pasteboard which has the running-out mechanism, since the cut part is formed after printing, it cannot print after that. Moreover, in the conventional separation style, the pasteboard is simply separated, and three-dimensional processing is not completed.

### SUMMARY OF THE INVENTION

In light of the forgoing, it is an object of the invention to provide an ordered card and system for manufacturing the ordered card that can produce a three-dimensional effect and make people fun and happy. It is another object of the invention to provide an ordered card and system for manufacturing the ordered card that it is easy to print for any order of applicant, and everyone can use efficiently.

Novel features which are believed to be characteristic of the invention, both as to its organization and method of operation, together with further objects and advantages thereof, are described below with reference to the accompanying drawings in which preferred embodiments of the invention are illustrated as an example.

It is to be expressly understood, however, that the drawings are for the purpose of illustration and description only, and are not intended as a definition of the limits of the invention.

### BRIEF DESCRIPTION OF THE DRAWINGS

FIG. 1 is an expanded view showing a first embodiment of the present invention;

FIG. 2 is a view when in use;

FIG. 3 is another view when in use;

FIG. 4 is a side view of the second embodiment of the present invention;

FIG. 5 is perspective view;

FIG. 6 is an exploded view showing a third embodiment of the present invention;

FIG. 7 is a back view of a cover;

FIG. 8 is a back view of a cover showing a fourth embodiment of the present invention;

FIG. 9 is a front view;

FIG. 10 is a view when in use;

FIG. 11 is a system view of the fifth embodiment of the present invention;

FIG. 12 is a view of an application form; and

FIG. 13 is a view of a control screen.

### DETAILED DESCRIPTION OF THE PREFERRED EMBODIMENTS

Preferred embodiments of the present invention are described in more detail below with reference to the accompanying drawings.

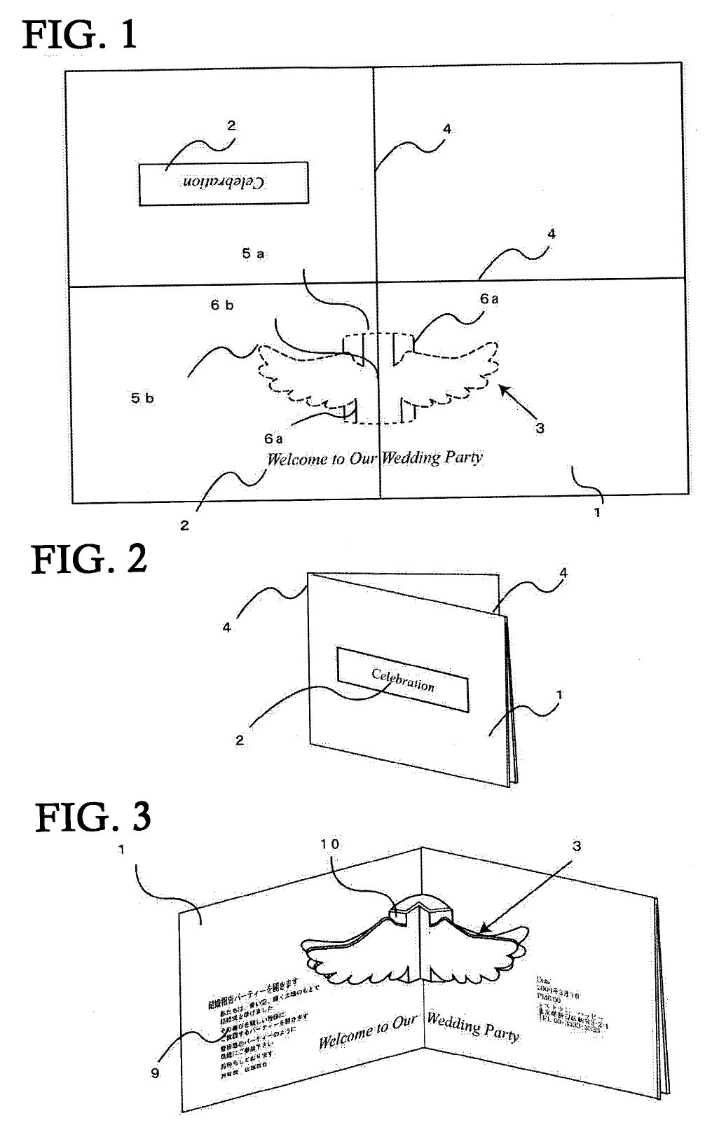

An understanding of the present invention may be best gained by reference to FIGS. 1-3. FIGS. 1-3 illustrate a winding device of a card in accordance with a first embodiment of the present invention. As shown in FIG. 1, the card in the present invention comprises a card body 1; a predetermined printing part 2 provided at the card body 1, using in common; a running-out part 3 which has the movable piece 10 provided so as to jump out from the card body 1 in three dimensions; and a fold part 4 of the card body, a perforation part 5 and a fold part 6 as means for forming the running-out part which can jump the running-out part 3 and the movable piece 10 out from the card body 1 in three dimensions.

The predetermined printing part 2 shows an invitation card for a wedding in this embodiment, the designs such as a frame which are ornamented and the title or letters of “Celebration” and “Welcome To Our Wedding Party” are printed at the cover used in common. Although not indicated in a figure, the running-out part 3 and the card body 1 may be printed any design, letters and the like Moreover, the printing column for printing the date and time of the event or invitatory sentences according to the customers situation is provided in the card body 1.

The fold part 4 of the card body 1 is provided at center parts vertically and horizontally of the card body 1. The fold part 4 is foldable and performed in any way, and it may be formed a printed fold part and fold part.

When the perforation part 5 is separated and the fold part 6 is folded, and the card body 1 is folded along the fold part 4, the running-out part 3 jumps out of the card body 1 in three dimensions. Then the fold part 6 may be printed a mark of the fold part.

The movable piece 10 is formed by the perforation part 5a, the fold part 6a and 6b in this embodiment. The fold part 6a and 6b has a duty of a turn-up and turn-down so that the movable piece 10 jumps out ahead.

Moreover, in this embodiment, a running-out piece formed in the shape of a wing is formed by a perforation part 5b so as to jump out ahead by interlocking the movable piece 10.

In addition, the combination of the perforation part 5 and fold part is not limited, the running-out part 3 may has a various formation.

When in use, as shown in FIG. 1, the card of the embodiment is printed without bending and separating the perforation part 5, there is the predetermined printing part 2 which can be used in common as mentioned above.

The perforation parts 5a and 5b are separated after printing, and the fold part 6 is folded, and then the movable piece 10 jumps out ahead. After that the running-out piece jumps out ahead along with this movable piece 10. In this embodiment, the wing jumps out ahead.

The fold part 4 is folded and complete formation is formed. In this invention, the card body is printed at one side thereof, and the fold part is formed horizontally and vertically so that contents may be understood easily. Therefore, the card body opens to right and left as shown in FIG. 2. As shown in FIG. 3, when it is opened, the running-out part 3 including the wing part can jump out so that It makes the customers happy and fun

In addition, both sides of the card body can be printed.

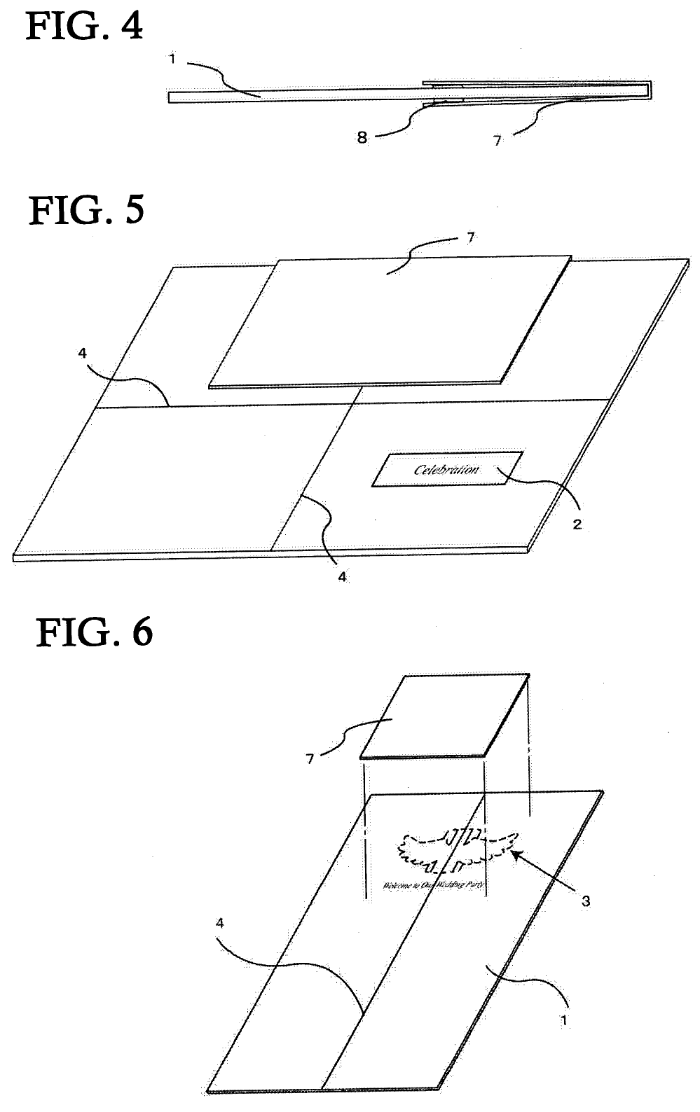

Other embodiments of the present invention will now be described with reference to FIGS. 4-13. In FIGS. 4-13, the same components as in the first embodiment described above with reference to FIGS. 4-13 are designated by the same reference numerals and therefore will not be further explained in great detail.

A second embodiment of the present invention is shown in FIGS. 4 and 5. It is distinguished from the first embodiment in that a cover part 7 with a thin sheet is used, and it prevents to catch in the running-out part 3 and be stained with unexpected ink.

The cover part 7 covers both surfaces of the running-out part 3. As shown in FIG. 4, an adhesion layer 8 is formed along both the tips of the cover part 7. The cover part 7 is fixed to card body 1 by the adhesion layer 8 so that the running-out part 3 is covered.

In addition, the place of the adhesion layer is not limited, and the adhesion layer achieves the function to fix the cover part in the range which does not give trouble to paper sending when printing. Since the perforation part is covered by the cover part, it can also be formed as a cut part so as to use as the running-out part beforehand.

When in use, as shown in FIG. 5, the card body 1 with the predetermined printing part 2 is opened, and it is inserted in the printer. In this case, the cuff part of the cover part 7 is inserted at first as a tip, and the printing column is printed. After that, the cover part 7 is removed after printing, the perforation part is separated, and the fold part 4 is folded. Then the running-out part 3 is formed.

Therefore, it prevents to be stained with unexpected ink when printing.

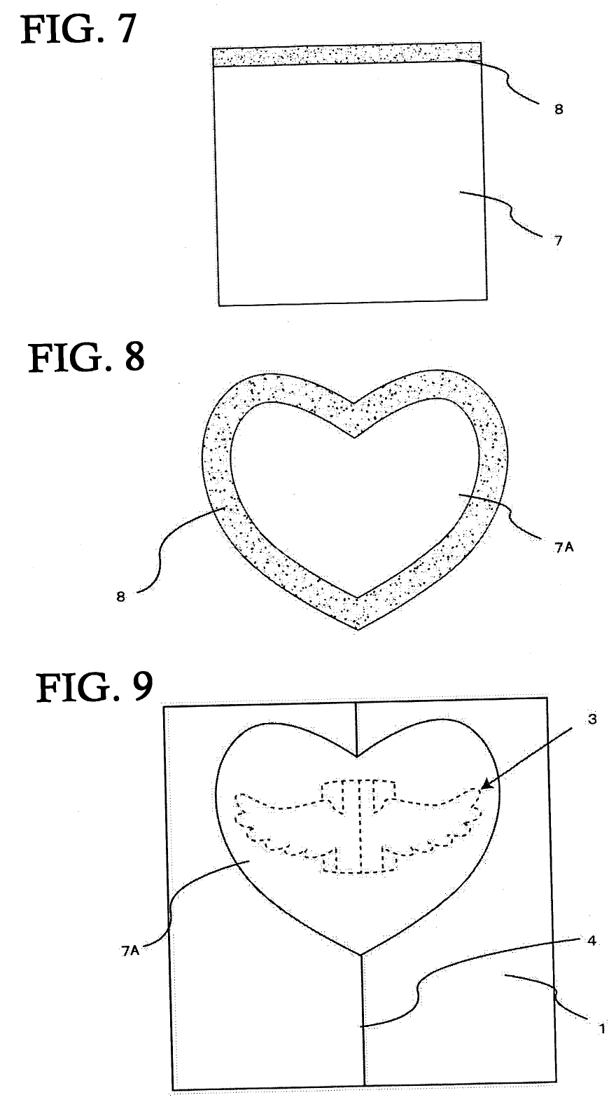

A third embodiment of the present invention is shown in FIGS. 6 and 7. It is distinguished from the second embodiment in that a card is used for the seat table in a wedding reception.

The cover part 7 is formed a size which can cover one side of the card body 1. Moreover, in this embodiment, the adhesion layer 8 is formed one end of the cover part 7. Therefore, the position as a head in accordance with the direction conveyed when printing is fixed by the adhesion layer 8.

In addition, although the cover part may be used only at the printing side, the cover part can also be used so as to cover the running-out part 3 from a back surface thereof.

A fourth embodiment of the present invention is shown in FIGS. 8-10. It is distinguished from the second embodiment in that a cover part 7A is formed in the shape of a heart, the adhesion layer 8 is formed at an outer circumferential part of the cover part 7A, and the cover part 7A is fixed to the card body 1.

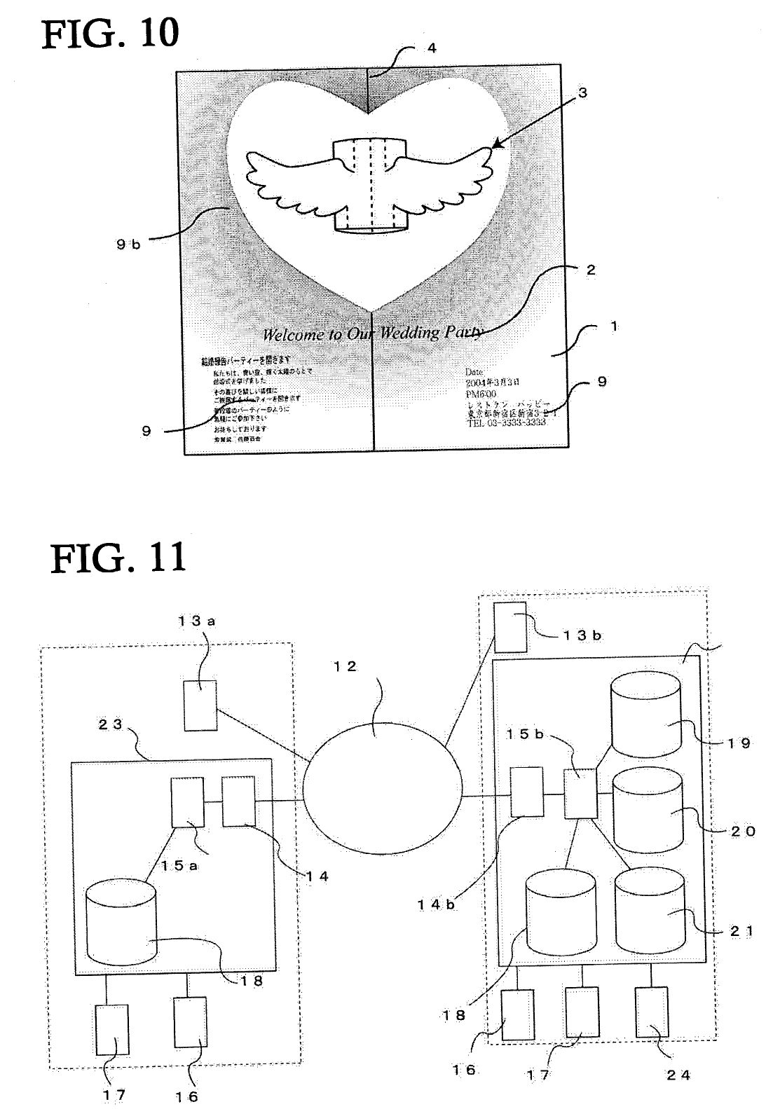

When in use, as shown in FIG. 10, the cover part 7A makes the role of masking by spurting out intentionally in the cover part 7A, and the outline of the shape of heart of the cover part 7 when it removed. Therefore, the new printing effect can be acquired.

A fifth embodiment of the present invention is shown in FIGS. 11-13. It is distinguished from the first embodiment in that a marketing system using the card is operated. In this system, a terminal for printing 23 and a management server 22 are connected to a public line network 12.

The management server 22 is installed in the manufacturing center, and it is connected to the public terminal. In addition, the management server 22 includes a card database 18 (DB), a customer DB 19 and an order information management DB 20, and a control part 15b manages.

The card DB 18 is store a plurality of card data including size of the card, pattern for folding, pattern for running-out shape, output data for forms, design pattern.

The customer DB 19 is stored customer data including ordered customer's name, address, telephone number and the like.

The order information management DB 20 is stored order information data with corresponding to an order form including card information checking space, inserted letters and ornaments, checking space for print information such as picture, design and the like and applicants name, address, telephone number and the like..

A product management DB 21 is stored manufactured goods data including output data so as to output to the specified card that is produced based on the order information.

Moreover, the management server 22 connects to a production terminal 24, and the production terminal 24 can manufacture the products.

The order information may be transmitted by a facsimile, so a facsimile machine 13b is connected to the public line. In this case, a scanner 25 can be used as a readable terminal.

A facsimile machine 13a is provided to send the applications as the order form in the event halls such as wedding, bridal fashion and the like. Then the facsimile machine 13a may be not provided when the order form is displayed on the screen of the computer and inputted the data, and the order information is transmitted.

The printing terminal 23 connects to the public line via a transceiver device 14a. The printing terminal 23 includes the card DB 18. In the control part 15a, the operator can confirm the complete portrait of the final product based on the product information and information in the card DB 18, and the data is printed via the connected printer.

An example of operation of the system is described below.

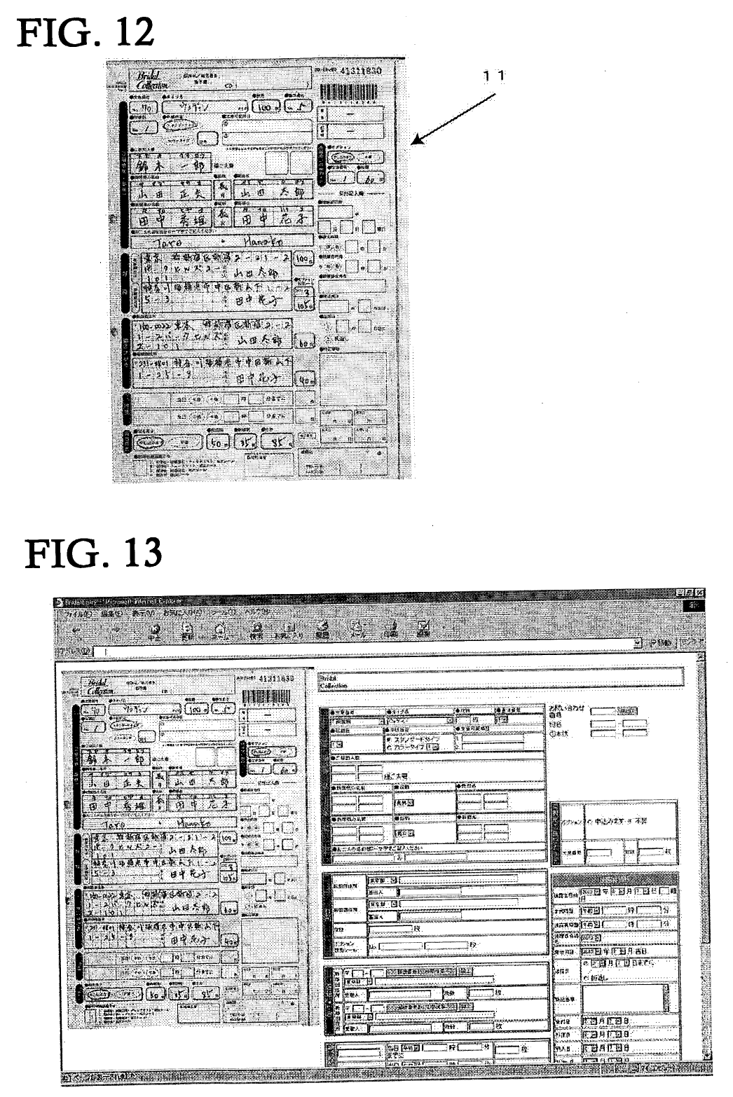

In a shop, at first, the customer decides a form of the card, design, predetermined sentences and the like. Then the operator inputs the details of order to the application form as shown in FIG. 12, and the application form is transmitted to the manufacturing center. After the production center is received the data, the order information is read via the scanner and stored in the database. At the same time, the production terminal is manufactured, and the output data is manufactured.

As shown in FIG. 13, the control screen has a screen displayed a layout of the application and a screen for inputting and manufacturing. The output data is stored in the database and transmitted to the output terminal via the transceiver device. The output terminal confirms the output data. When the data is right, the data is printed exactly the same data. When the data is not right, the operator calls to the production center, the data is corrected. Moreover, the output terminal may have a database that stores the output data.

In the applying, the data is inputted on the screen, of course. When the application form is a paper, a soft in the facsimile terminal and device with OCR function may be used

In addition, the application is transmitted from the shop, personal facsimile terminal, terminals including personal computer and the like.

As set forth above, the advantages of the invention are as follows:

(1) A card comprises a card body; a running-out part provided at the card body; means for forming the running-out part, capable of jumping the running-out part out from the card body in three dimensions; an predetermined printing part provided at the card body, using in common; and a printing column provided at the card part except for a part of means for forming the running-out part so that printing can be performed to the paper having means for forming the running-out par using a printer.

Therefore, it can produce a three-dimensional effect and makes people fun and happy.

(2) As discussed above, the cover body covered detachably means for forming the running-out part is provided so that it prevents the paper jam when printing.

(3) As discussed above, since it has a simple structure, it can be performed easily.

Therefore, it is easy to reduce its cost.

What is claimed is:

1. A card comprising:
a card body;
a running-out part provided at the card body;
means for forming the running-out part, capable of jumping the running-out part out from the card body in three dimensions;
an predetermined printing part provided at the card body, using in common; and
a printing column provided at the card part except for a part of means for forming the running-out part.

2. A card according to claim 1, wherein the forming means is a perforation part and a fold part

3. A card according to claim 1, wherein the forming means is a cut part and a fold part.

4. A card according to claim 1, further comprising:
a cover body which covers detachably the forming means.

5. A system for manufacturing the card comprising:
a device for transmitting an order information based on an order form including a card information checking space with means for forming a running-out part, inserted letters and ornaments, a checking space for print information such as one of pictures and design and an applicants name, address and telephone number;
a device for receiving order information from the transmitting device;
a management server including a card database (DB) storing a card information, a customer DB, a management DB managing an order information, and a management DB managing an output information provided based on the order information;
a production device provided connectably to the management server;
a device for transmitting the output information produced;
a device for receiving the output information;
an output terminal including a printer; and
characterized in that at least each of transmitter and receivers is connected to a public line.

6. A system for manufacturing the card according to claim 5, wherein one of the device for transmitting an order information and device for receiving includes a OCR function, capable of getting a part of the order information.
